(19) United States
(12) Patent Application Publication
(10) Pub. No.: US 2022/0405138 A1
(43) Pub. Date: Dec. 22, 2022

(54) DETECTING PROCESSES CAUSING DEGRADATION OF MACHINE PERFORMANCE USING HEURISTICS

(71) Applicant: Citrix Systems, Inc., Fort Lauderdale, FL (US)

(72) Inventors: PN Prathima, Bangalore (IN); Vikramjeet Singh, Bangalore (IN); Mukesh Garg, Bangalore (IN); Venkatesh Vellingiri, Bangalore (IN); Vivek Koni Raghuveer, Bangalore (IN); Syed Mansoor Pasha, Bangalore (IN); Sharath Babu, Bangalore (IN); Kamal Deka, Bangalore (IN); Ramnath Repakula, Bangalore (IN)

(73) Assignee: Citrix Systems, Inc., Fort Lauderdale, FL (US)

(21) Appl. No.: 17/391,391

(22) Filed: Aug. 2, 2021

(30) Foreign Application Priority Data
Jun. 21, 2021 (IN) 202121027590

(51) Int. Cl. G06F 9/50; G06F 11/34

(52) U.S. Cl. CPC G06F 9/5005; G06F 11/3495

(57) ABSTRACT

Described are systems and methods of detecting processes causing degradation of machine performance using heuristics. A device may identify a plurality of time intervals having a use of a resource on a machine above a threshold. The device may identify a percentage of the use of the resource by each of a plurality processes on the machine using the resource during each time interval of the plurality of time intervals. The device may determine a score for each process of the plurality processes based at least on a function of the percentage of the use of the resource over one or more of the plurality of time intervals in which each process used the resource. The device may provide, for display, a selection of one or more processes from the plurality of processes ranked by the score.

### CROSS-REFERENCE TO RELATED APPLICATION

This application claims priority to and the benefit of Indian Provisional Patent Application No. 202121027590, titled “DETECTING PROCESSES CAUSING DEGRADATION OF MACHINE PERFORMANCE USING HEURISTICS,” and filed on Jun. 21, 2021, the contents of all of which are hereby incorporated herein by reference in its entirety for all purposes.

### FIELD OF THE DISCLOSURE

The present application generally relates to instrumentation. In particular, the present application relates to systems and methods for detecting processes causing degradation of machine performance using heuristics.

### BACKGROUND

While running on a client, the application may use fluctuating amounts of computing resources such as processing power and memory to perform various functions. Due to the changing amounts of computer resources consumed by the application, the user experience with respect to the client and the application may also vary.

### BRIEF SUMMARY

Performance analytics may quantitatively measure user experience during a session using various factors affecting the session, such as logon duration, session responsiveness, and session resiliency. When a user launches a virtual application or desktop session on a client, the user may still face poor experience, despite having all these factors in an excellent range. The poor experience may be due to a slow, sluggish, or even unresponsive client, leading to a degradation of overall machine performance. This may create a gap between end-users complaining of poor experience and administrator having no visibility into the machine performance. The mismatch between the user and administrator may often leave the administrator with the option of restarting the local machine, thereby impacting other users that are running sessions on the same machine.

One attempt at addressing these issues may include presenting an interface showing the resource consumption of processes that are running on the machine currently to the administrator. The interface, however, may lack any additional insights to the potential causes of the degradation of machine performance, such as correlation or other analysis with resource consumption of resources at the machine. Without the provision of any additional analysis, the administrator may have to manually investigate the cause of the poor performance, potentially leading to inaccurate and inconsistent diagnosis or even inability to come to a conclusion.

To address these and other technical challenges, a performance analytics system may provide a process view or an interface presenting suspect processes automatically determined using heuristics. The interface may provide a historic view of the various processes to allow the administrator to further investigate various processes. Using the interface, the administrator may have visibility to processes at the machine level and pinpoint problematic processes causing peaks in processor and memory usage and thus deterioration of user experience. The interface may also permit the administrator to take various actions such as terminating processes determined to be the cause of the poor user experience. The performance analytics system may determine which processes lead to the machine performance to degrade and the which actions to recommend with respect to such suspect processes.

The performance analytics system may first run a root cause analysis on the processes running on a given machine to identify the processes causing the degraded performance. The identified suspect processes may be displayed to the administrator in the interface for each machine. The top n processes consuming more computing resources (e.g., processing power, memory usage, and disk consumption) can be viewed at each resource type using the interface. When poor user experience is detected or reported, the administrator may navigate through the interface to drill down to investigate sessions themselves and machines on which the sessions are running. From selecting a machine name, the administrator may obtain visibility to statistics on the machine and individual processes executing on the machine.

The processes may have been automatically determined as problematic and selected for presentation on the interface in accordance with heuristics. The heuristics may specify that a number (e.g., 20%) of processes that in aggregate contribute to a threshold percentage (e.g., 80%) of the resource consumption at a given time interval are to be selected for presentation. The number of processes and the threshold percentage may be fixed as defined by the administrator or dynamically set in accordance with the customer environment. The resources considered may include processor, memory, and disk consumption, among others. The data points used in the analysis may include a process identifier, time, resource consumption, and a time interval during which the consumption of the machine resource spiked. The time interval in which the resource spike occurred may be correlated with the processes running in the same time period. The percentage of resource consumption of a given process across time intervals may be used to calculate an aggregate score for the process.

Once the individual scores are determined, the performance analytics system may select the top n processes that contribute to 80% of the resource consumption. With the selection, the performance analytics system may generate and provide a timeline view of resource consumption of the selected processes. The administrator can use the timeline to investigate and confirm whether the identified processes were indeed contributing to the poor user performance. The timeline view may also assist the administrator in gaining confidence and affirming evaluations of the machines and processes before performing any remedial actions to alleviate the user experience. The view may further allow the administrator to investigate correlations between the processes and the resource consumption on the machine, as well as confirm which processes coincided with the maximum number of times with resource consumption peaks.

With the identification of processes, the administrator may select various actions to perform on the processes to alleviate the user experience. For example, the administrator may terminate one of the processes determined to contribute to abnormally high consumption of computer resources. The termination of such processes may help improve the performance of the machine and by extension more likely to improve user experience. Furthermore, the actions may be extended to having automated actions configured on the processes by a workspace environment management.

In this manner, the performance analytics system may provide an interface and various views showing processes that potentially contribute the degradation in machine performance and by extension issues with user experience. The interface may thus allow the administrator to easily investigate the cause of the poor user experience, and quickly take actions to mitigate the contributory factors on the given machine running on the session. Relative to other approaches, the administrator may be freed from the burden of having to individually investigate and examine various processes in deciding the cause of the poor user experience. Instead, the performance analytics system may use heuristics to determine an analysis and correlations regarding processes identified as leading to resource peaks on a machine.

Aspects of the present disclosure are directed to systems, methods, and non-transitory computer readable media for detecting processes causing degradation of machine performance using heuristics. A device may identify a plurality of time intervals having a use of a resource on a machine above a threshold. The device may identify a percentage of the use of the resource by each of a plurality processes on the machine using the resource during each time interval of the plurality of time intervals. The device may determine a score for each process of the plurality processes based at least on a function of the percentage of the use of the resource over one or more of the plurality of time intervals in which each process used the resource. The device may provide, for display, a selection of one or more processes from the plurality of processes ranked by the score.

In some embodiments, the device may select the one or more of processes from the plurality of processes ranked by highest score and for which a sum of the scores at least meets a second threshold. In some embodiments, the device may identify, for each of the plurality of processes, an identifier of a user using the process. In some embodiments, the device may, for display, the score and the identifier of the user for each of the plurality of processes.

In some embodiments, the device may identify a number of times each of the plurality of processes across the plurality of time intervals identified as having the use of the resource on the machine above the threshold. In some embodiments, the device may provide, for display, a ranked order of the number of times that each of the plurality of processes is identified as having the use of the resource on the machine above the threshold across the plurality of time intervals.

In some embodiments, the device may provide, for display, a timeline view for a process of the one or more processes to show usage of the resource by the process at each of the plurality of time intervals. In some embodiments, the device may identify, responsive to detecting a degradation of a session, the plurality of time intervals from the session

In some embodiments, the device may identify the percentage of the use of the resources by each of the plurality processes on the machine above a second threshold. In some embodiments, the device may provide an instruction to perform an action to at least one of the one or more processes based at least on the score for each of the one or more processes.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of an embodiment of a system for detecting processes causing degradation of machine performance using heuristics in accordance with an illustrative embodiment;

FIG. 4 is a graph of a resource consumption level and processes running on a client over multiple time intervals in accordance with an illustrative embodiment;

FIG. 5 is a screenshot of a graphical user interface of an analytics platform presenting session-related performance parameters over time intervals in accordance with an illustrative embodiment

FIG. 6 is a screenshot of a graphical user interface of an analytics platform presenting session-related performance parameters over time intervals for a particular user in accordance with an illustrative embodiment; and

FIG. 7 is a flow diagram of an embodiment of a method of detecting processes causing degradation of machine performance using heuristics in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein;

Section B describes resource management services for managing and streamlining access by clients to resource feeds; and

Section C describes systems and methods for detecting processes causing degradation of machine performance using heuristics.

### A. Computing Environment

Prior to discussing the specifics of embodiments of the systems and methods of an appliance and/or client, it may be helpful to discuss the computing environments in which such embodiments may be deployed.

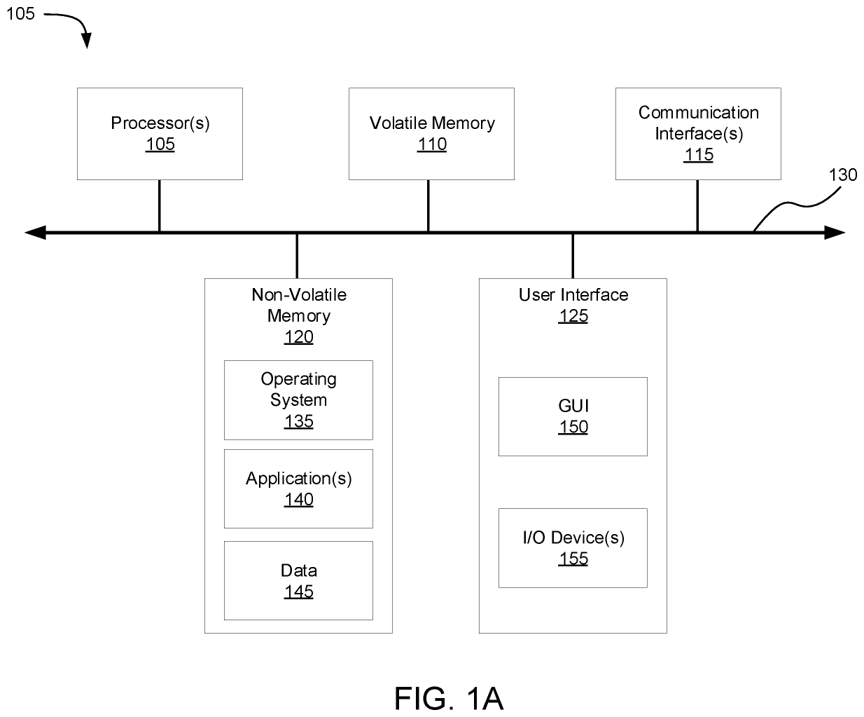

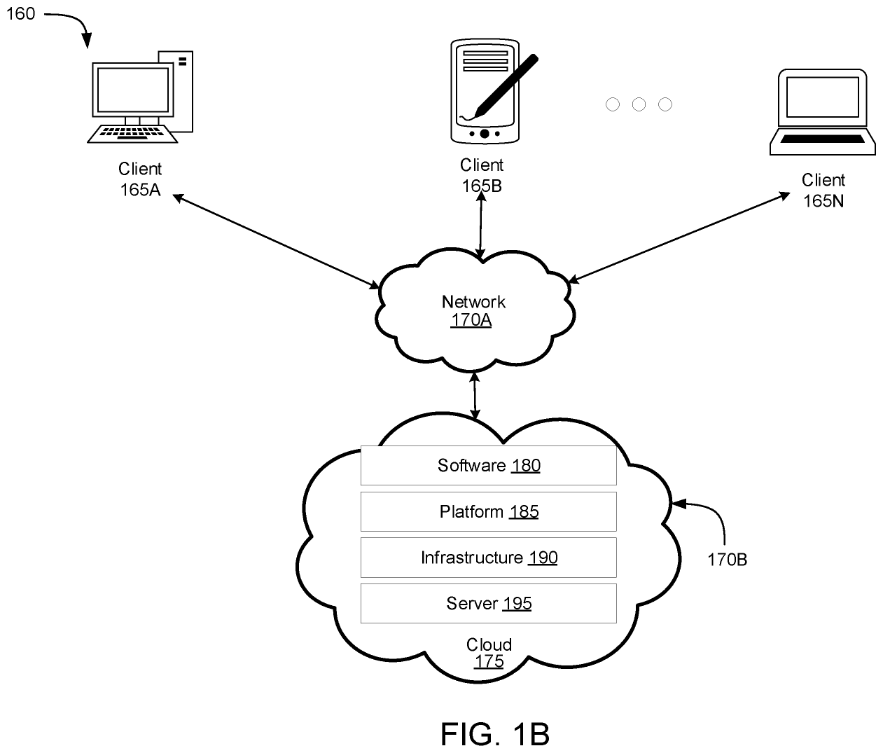

As shown in FIG. 1A, computer 100 may include one or more processors 105, volatile memory 110 (e.g., random access memory (RAM)), non-volatile memory 130 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 135, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 130 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 135 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170. Clients 165 may include, e.g., thick clients, thin clients, and zero clients. The cloud 108 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

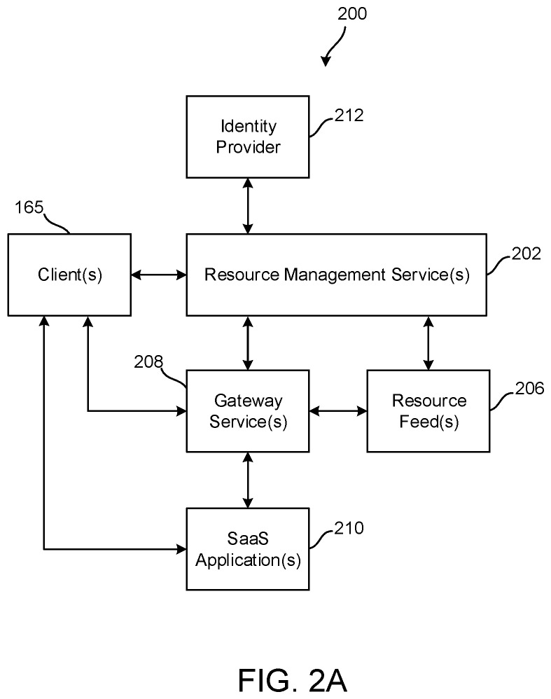

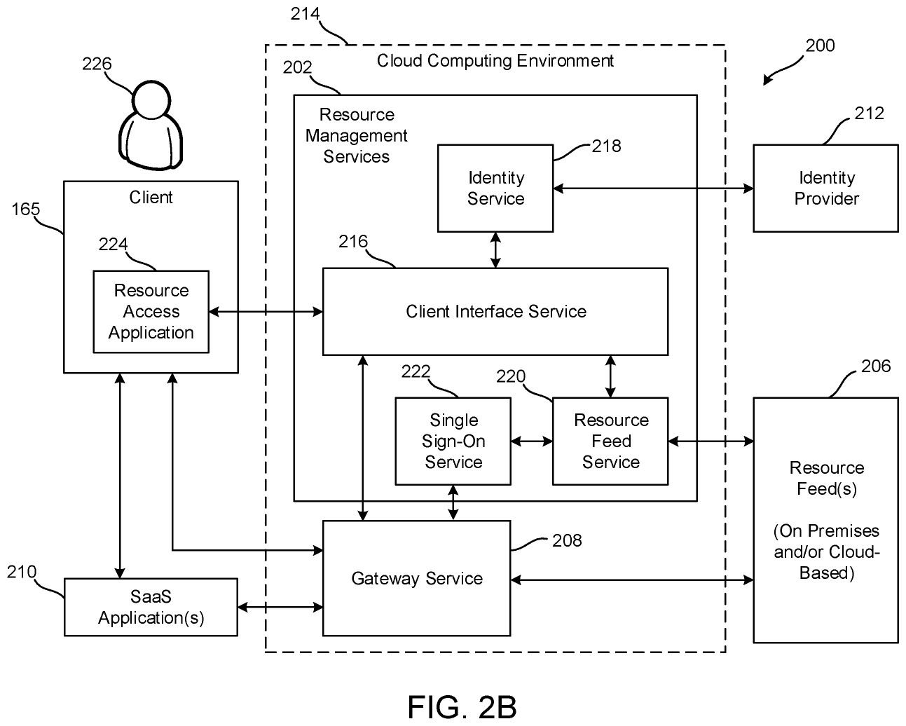

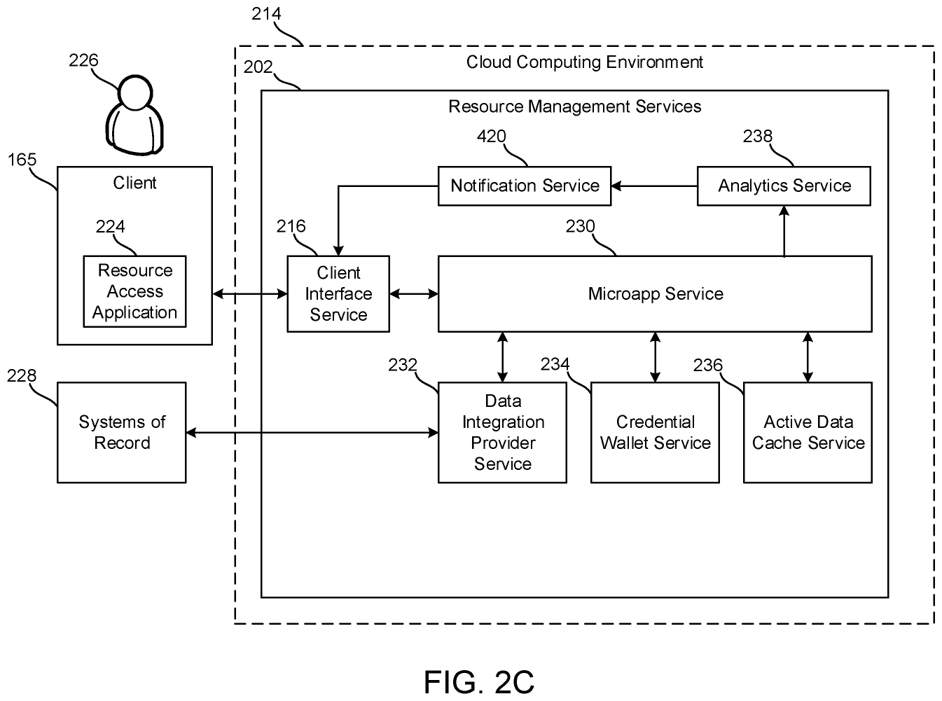

FIG. 2A is a block diagram of an example system 200 in which one or more resource management services 202 may manage and streamline access by one or more clients 202 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 202 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 202, one or more file repositories and/or file sharing systems, one or more secure browser services, one or more access control services for the SaaS applications 210, one or more management services for local applications on the client(s) 202, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6 ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted Oauth2 token for the system of record for which the action is to be invoked, and may send the action to the data integration provider service 232 together with the encrypted Oath2 token. The data integration provider service 232 may then decrypt the Oath2 token and write the action to the appropriate system of record under the identity of the user 226. The data integration provider service 232 may then read back changed data from the written-to system of record and send that changed data to the microapp service 230. The microapp service 232 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back-end. In some embodiments, users may be able to interact with the virtual assistance through either the resource access application 224 or directly from another resource, such as Microsoft Teams. This feature may allow employees to work efficiently, stay organized, and deliver only the specific information they are looking for.

### C. Systems and Methods for Detecting Processes Causing Degradation of Machine Performance Using Heuristics

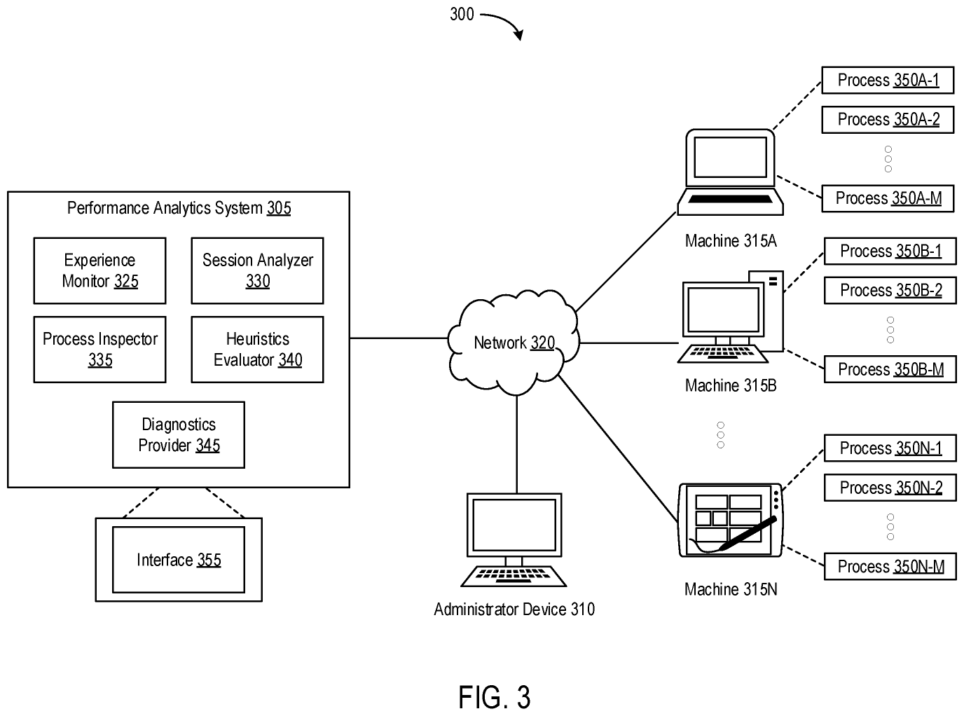

Referring now to FIG. 3, depicted is a block diagram of a system 300 for detecting processes causing degradation of machine performance using heuristics. The system 300 may include at least one performance analytics systems 305, at least one administrator device 310, and one or more machines 315A-N (hereinafter generally referred to as machines 315) communicatively coupled with one another via at least one network 320. The performance analytics systems 305 may include at least one experience monitor 325, at least one session analyzer 330, at least one process inspector 335, at least one heuristics evaluator 340, and at least one diagnostics provider 345, among others. In some embodiments, the administrator device 310 may be part of the performance analytics system 305 may be part of the same device or may be separate devices (e.g., as depicted). Each machine 315 (also referred herein as a machine) may be a client (e.g., the client 165) or a server (e.g., the server 195) that executes or runs one or more processes 350A-1 to 350N-M (hereinafter generally referred to as processes 350). In some embodiments, the machine 315 may correspond to a virtual machine (e.g., with a virtual delivery agent (VDA)) running on the client, the server, or one or more nodes on the cloud (e.g., the cloud 175 or cloud computing environment 214) to execute the processes 350. The performance analytics system 305 may include or provide at least one interface 355.

Each of the above-mentioned elements or entities is implemented in hardware, or a combination of hardware and software, in one or more embodiments. Each component of the system 300 may be implemented using hardware or a combination of hardware or software detailed above in connection with Sections A and B. For instance, each of these elements or entities can include any application, program, library, script, task, service, process or any type and form of executable instructions executing on hardware of the system 300, such as the performance analytics system 305 and its components (e.g., the session monitor 320 ,the session analyzer 330, the resource inspector 335, the heuristics evaluator 340, the diagnostic provider 345, and the interface 355) and the machines 315 and its components (e.g., the processes 350). The hardware includes circuitry such as one or more processors in one or more embodiments.

Each machine 315 may run or execute one or more processes 350 in one or more sessions. The machine 315 may be a local computing device operating by the user or a remote virtual machine running on one or more network devices accessed by the user. The processes 350 may include an instance of an application, program, or programmable instructions running on the machine 315. For example, the processes 350 may include an operating system service (e.g., a background process), a word processor, a multimedia player, an image editor, a spreadsheet tool, a web browser, a video game, or an instant messaging program, among others. The processes 350 may rely on computing resources local to the machine 315, such as a processor, memory, disk storage, and renderer (e.g., a graphical processor unit (GPU)), among others. The session may correspond to or refer to a period of activity between one or more users and the machine 315 to access and use various processes 350. In some embodiments, the start of the session may correspond to a login to an operating system on the machine 315 and the end of the session may correspond to a logout from the operating system on the machine 315. In some embodiments, the start of the session may correspond to a login or initiation of a virtual desktop presented via the machine 315 from a remote machine and the end of the session may correspond to a logout or termination of the virtual desktop presented via the machine 315 from the remote machine.

The experience monitor 325 executing on the performance analytics system 305 may monitor the session at each machine 315 for an issue with user experience. In monitoring, the experience monitor 325 may measure or monitor for user experience related metrics at the machine 315 or the processes 350 on the machine 315. The user experience related metrics may include various computer performance measures. The metrics may include, for example, a response time for each process 350, a number of reconnection attempts, an error rate, a frequency of user interactions, a processing speed, among others. The metrics may be measured and kept track by the machine 315. For example, the operating system on the machine 315 may maintain information regarding computer performance of the machine 315. The experience monitor 325 may access the machine 315 (or the operating system on the machine 315) to obtain the user experience metrics.

Based on the metrics, the experience monitor 325 may generate, calculate, or determine a user experience score for the machine 315. The determination of the user experience score may be based on a function (e.g., weighted sum) of the user experience metrics acquired from the machine 315. In general, the higher the user experience score is, the user may more likely be experiencing satisfactory experience. Conversely, the lower the user experience is, the user on the machine 315 may more likely be facing unsatisfactory experience with the processes 350. With the determination, the experience monitor 325 may compare the user experience score to a threshold. The threshold may define a value for the user experience score at which the user at the machine 315 or the session on the machine 315 is considered to be satisfactory or unsatisfactory user experience. Based on the comparison, the experience monitor 325 may determine whether the user experience of the user of the machine 315 (or the session) is satisfactory or unsatisfactory.

When the user experience score is above (e.g., greater than or equal to) the threshold, the experience monitor 325 may determine that user experience is satisfactory. The experience monitor 325 may further determine that there is no issue with or degradation of user experience at the machine 315, and may continue to monitor the machine 315. On the other hand, when the user experience is below (e.g., less than) the threshold, the experience monitor 325 may determine that the user experience is unsatisfactory. The experience monitor 325 may also determine that there is an issue with or degradation of with user experience at the machine 315. The experience monitor 325 may also initiate a root cause analysis of the machine 315 (or the session on the machine 315) to determine the cause for the unsatisfactory user experience.

In some embodiments, the experience monitor 325 may wait for a notification of user experience from the machine 315. For example, the user of the machine 315 may report or indicate the user experience via a prompt displayed at the machine 315 to the performance analytics systems 305 Upon receipt, the experience monitor 325 may parse the notification to identify the reported user experience. If the notification indicates satisfactory user experience, the experience monitor 325 may determine that user experience is satisfactory. The experience monitor 325 may further determine that there is no issue with or degradation of with user experience at the machine 315, and may continue to monitor the machine 315. Conversely, if the notification indicates unsatisfactory user experience, the experience monitor 325 may determine that the user experience is unsatisfactory. The experience monitor 325 may also determine that there is an issue with or degradation of with user experience at the machine 315. The experience monitor 325 may also initiate a root cause analysis of the machine 315 (or the session on the machine 315) to determine the cause for the unsatisfactory user experience.

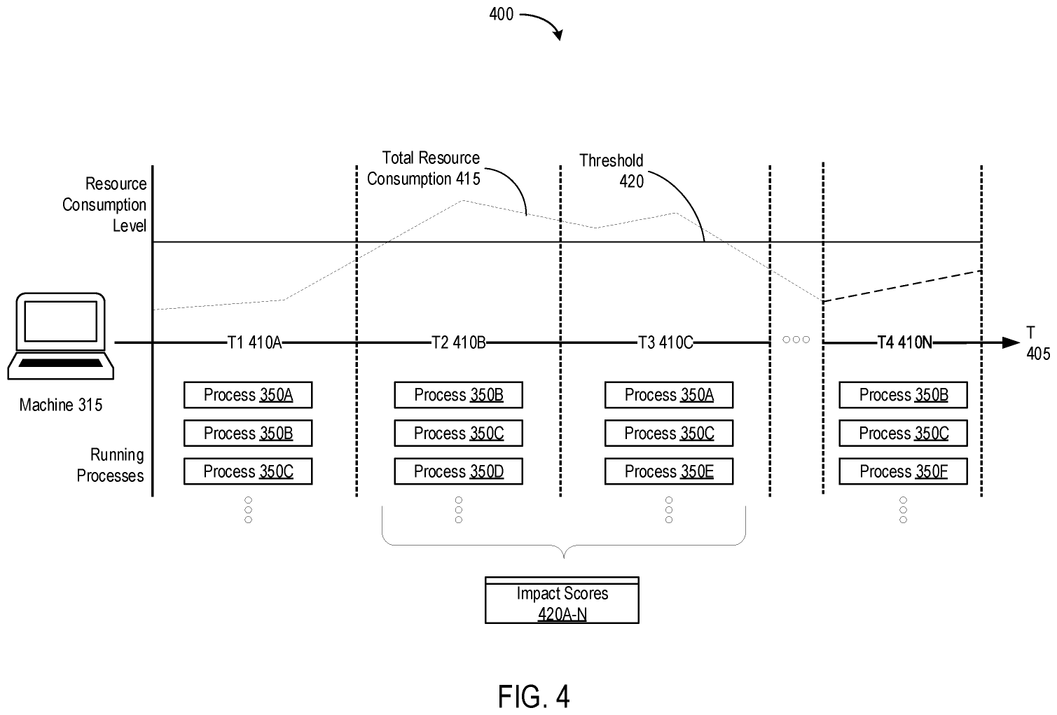

Referring to FIG. 4, among others, depicted is a graph 400 of a resource consumption level and processes running on a client over multiple time intervals in a session. In the context of the system 300, the machine 315 determined to have an issue with user experience may have accessed and run various processes 350 across a time period 405 (labeled “T” in the depiction). The time period 405 may correspond to at least a portion of the period of the user session at the machine 315. For example, the time period 405 may span from a time point when the user logged and started the session at the client 305 to a subsequent time point when user experience issues were detected. The time period 405 may be divided into one or more time intervals 410A-N (hereinafter generally referred to as time intervals 410). The time intervals 410 may range from minutes, hours, days, weeks, or months. For instance, the time interval 410 may divide the period of time 405 for the session into 15 minutes blocks. Both the time period 405 and the time interval 410 may be measured in terms of seconds, minutes, days, weeks, or months, or any unit for keeping track of time. From running the various processes 350, the machine 315 may consume varying levels of resource consumption 415 across the time intervals 410 during the time period 405 of the session.

The session analyzer 330 executing on the performance analytics system 305 may identify one or more time intervals 410 from the time period 405. For each time interval 410, the session analyzer 330 may determine or identify the total level of resource consumption 415 in the time interval 410 by the machine 315. The total level of resource consumption 415 may correspond to usage of various types of computing resources on the machine 315. The total level of resource consumption 415 may identify the processor, memory, disk space, or renderer, among others or any combination thereof by all the processes 330 running on the machine 315 within the time interval 410. In some embodiments, the session analyzer 330 may determine the total level of resource consumption 415 using one of the usage metric type. For example, the session analyzer 330 may calculate the total level of CPU usage and total level of memory consumption separately at each time interval 410 in the time period 405. In some embodiments, the session analyzer 330 may determine the total level of resource consumption 415 using a combination of the usage metric types.

With the identification in each time interval 140, the session analyzer 330 may determine whether the total level of resource consumption 415 is above a threshold 420. The threshold 420 may delineate or define a value for the total level of resource consumption 415 at which to select the associated time interval 410 for additional analysis. In some embodiments, the threshold 420 may be fixed (e.g., defined by the administrator). In some embodiments, the threshold 420 may be dynamically determined using previous user experience scores. For example, the value for total level of resource consumption 415 correlated to the unsatisfactory user experience may be used as the threshold 420.

If the total level of resource consumption 415 is above (e.g., greater than or equal to) the threshold 420, the session analyzer 330 may select or identify the time interval 410 as included for further analysis. From the time period 405, the session analyzer 330 may select or identify the one or more time intervals 410 having total levels of resource consumption 415 above the threshold 420. In the depicted example, the session analyzer 330 may identify the second time interval 410B and the third time interval 410C as having total levels of resource consumption 415 above the threshold 420. In some embodiments, the session analyzer 330 may select time intervals 410 adjacent to the time interval 410 identified as having total levels of resource consumption 415 above the threshold 420 for additional analysis.

Conversely, if the total level of resource consumption 415 is below (e.g., less than) the threshold 410, the session analyzer 330 may select or identify the time interval 410 as excluded for further analysis. From the time period 405, the session analyzer 330 may select or identify the one or more time intervals 410 having total levels of resource consumption 415 below the threshold 420. In the illustrated example, the session analyzer 330 may identify the first time interval 410A and the last time interval 410N, among others, as having total levels of resource consumption 415 below the threshold 420.

The process inspector 335 executing on the performance analytics system 305 may determine or identify the processes 350 running on the machine 315 at each time interval 410 identified as having the total level of resource consumption 415 above the threshold 420. The processes 350 identified by the process inspector 335 may include any instance of an application, program, or programmable instructions running on the machine 315 in the identified time interval 420. For instance as depicted, both the second time interval 410B and the third time interval 410C may have been identified as having total levels of resource consumption 415 above the threshold 420. In this example, the process inspector 335 may identify the processes 350B, 350C, and 350D as running during the second time interval 410B and the processes 350A, 350C, and 350E as running during the third time interval 410C.

With the identification, the process inspector 335 may calculate, determine, or identify a number of times each process 350 is running during the identified time intervals 410. The number of times may define, indicate, or identify the number of times that the process 350 coincides with time intervals 410 in which the level of resource consumption 415 is above the threshold 420. For instance, from the second time interval 410B and the third time interval 410C, the process inspector 335 may determine the number of times that the process 350C underwent peak resource consumption as twice and the number of times that the remaining processes 350A, 350B, 350D, and 350E as once. In some embodiments, the process inspector 335 may identify the number of times for each process 350 by usage metric type. For example, the process inspector 335 may identify that the process 350B as coinciding to peak memory usage once during the second time interval 410B. In addition, the process inspector 335 may identify the process 350C as coinciding with peak CPU usage twice over the second time interval 410B and the third time interval 410C.

In some embodiments, the process inspector 335 may identify various information associated with the processes 350 running during the identified time intervals 410. In some embodiments, the process inspector 335 may identify a process identifier for each process 350. The process identifier may reference or uniquely correspond to the process 350. The process identified may be, for example, retrieved by invoking an application programming interface (API) of the operating system (e.g., using the GetCurrentProcessID( ) function under Windows API). In some embodiments, the process inspector 335 may identify a process name for each identified process 350. The process name may reference or correspond to the process 350 running on the machine 315, such as an application name, a file name, or a uniform resource identifier (URI), among others. In some embodiments, the process inspector 335 may identify a user identifier using the process 350 on the machine 315. The user identifier may reference or correspond to the user or an account associated with the user using the process 350 on the machine 315. For example, the user identifier may correspond to the account identifier used to login to the session to access the processes 350 through the machine 315.

For each identified process 350 in the time intervals 410, the process inspector 335 may calculate, identify, or otherwise determine a percentage of usage of the resource of the machine 315 by the process 350 in each identified time interval 410. The percentage of usage may measure, indicate, or correspond to an amount of resources consumed by the process 350 relative to the total level of resource consumption 415 during the corresponding time interval 410. In some embodiments, the process inspector 335 may determine the percentage of usage of the resource for each process 350 at the machine 315 by usage metric type, such as processor, memory, disk, or renderer, among others. For example, the process inspector 335 may calculate separate percentages of usage by a given process 350 over one time interval 410 by CPU usage, memory, and disk consumption, among others.

In some embodiments, the process inspector 335 may identify or select a subset of identified processes 350 with percentage of usage above a threshold. The threshold may define or identify a value for the percentage of usage at which to select the associated process 350 for further analysis. For example, the threshold may be set to remove processes 350 with relatively minimal usage of the resources on the machine 315. For each process 350, the process inspector 335 may compare the percentage of usage of the resource to the threshold. If the percentage of usage is above (e.g., greater than or equal to) the threshold, the process inspector 335 may select the process 350 for further analysis. Otherwise, the process inspector 335 may remove the process 350 from additional analysis. In some embodiments, the process inspector 335 may determine a ranking of the processes 350 by percentage of usage for each identified time interval 410. In the example of Table 1 below, the session analyzer 330 may have identified three 15 minute time intervals 410, 9:00-9:15, 9:15-9:30, and 9:30-9:45 having the total level of consumption 415 exceeding the threshold 420. The process inspector 335 may in turn identify processes 350 “A”, “B”, “C”, “D”, and “E” as coinciding with the three time intervals 410. The process inspector 335 may also select a subset of processes 350 with percentages of usage of resources above another threshold, and then rank the identified processes 350 by percentages.

TABLE 1
Processes “A”-“E” identified as coinciding with time intervals
that have levels of resource consumption above the threshold.

| | Time Intervals | | |
|---|---|---|---|
| | 9:00-9:15 | 9:15-9:30 | 9:30-9:45 |
| “A” | 55% | | |
| “B” | 5% | | |
| “C” | 10% | | |
| “D” | | 20% | |
| “E” | | 5% | |
| “A” | | 65% | |
| “D” | | | 75% |
| “C” | | | 5% |
| “A” | | | 10% |

The heuristics evaluator 340 executing on the performance analytics system 305 may calculate, generate, or otherwise determine an impact score 420A-N (hereinafter generally referred to as an impact score 420) for each identified process 350. The impact score 420 (also herein generally referred to as a score) may define, identify, or indicate a degree to which the associated process 350 contributes to the total level of resource consumption 415 over the identified time intervals 410. The time intervals 410 accounted for in the determination of the impact score 420 may include those identified as having the total level of resource consumption 415 above the threshold 420. The heuristics evaluator 340 may determine the impact score 420 for each process 350 using a function of the percentage of usage of the resource by the process 350 and the time intervals 410 in which the process 350 is identified. For example, the function used to calculate the impact score 420 may be in the form of:

$$Impact Score = {\sum }_{k = 0}^{N} \frac{\begin{matrix}Resource Consumption \% * \\ Machine Peak at {T}_{k}\end{matrix}}{N}$$

wherein k refers to the time interval 410, Machine Peak at Tₖ is 1 when the total level of resource consumption 415 is above the threshold 420 and is otherwise 0 when the total level of resource consumption 415 is below the threshold 420, and N refers to the total number of time intervals 410 over the time period 405 in which the total lever of resource consumption 415 is identified as above the threshold 420.

In determining the impact score 420 for each process 350, the heuristics evaluator 340 may determine or identify the percentages of usage of the resource at the machine 315 across the time intervals 410 in which the process 350 is identified. Upon identification, the heuristic evaluator 340 may calculate or determine a combination (e.g., a sum, a weighted sum, or an average) of the percentages of usage of the resource at the machine 315 in accordance with the function. The heuristics evaluator 340 may count, determine, or identify the number of time intervals 410 in which the process 350 of the subset is identified. The heuristics evaluator 340 may then calculate or determine the total impact score 420 for each process 350 based on the combination of the percentages and the number of time intervals 420 in accordance with the function. For example, the heuristics evaluator 340 may use the quotient of the sum of the percentages of the percentages of usage and the number of time intervals 420 as the total impact score 420 for each process 350. In some embodiments, the heuristics evaluator 340 may determine the impact score 420 for each process by usage metric type.

In the example of Table 2 below, the heuristic evaluator 340 may identify processes 350 “A”-“E” as consuming the highest usage of resources at the machine 315 across the one or more of the time intervals 410, 9:00-9:15, 9:15-9:30, and 9:30-9:45. With the identification, the heuristics evaluator 340 may determine the number of coinciding intervals 410 and the sum of the percentage of usage for each of the processes 350. For process 350 “C”, the heuristics evaluator 340 may determine that the number of coinciding time intervals 420 is two (9:00-9:15 and 9:30-9:45) and that the sum of the percentage of usage of the resource is 95. Using the sum and the number of coinciding time intervals 410, the heuristics evaluator 340 may calculate the total impact scores 420. For process “D”, the heuristics evaluator 340 may determine a total impact score 420 as a quotient of the sum of the percentage of usage (95) and the number of coinciding time intervals (2) to yield a value of 47.5.

TABLE 2
Calculation of total impact scores based on the sum of the percentage of usage
over the number of coinciding time interval in accordance with the function.

| | Time Intervals | | | | Number of | Summation of | |
|---|---|---|---|---|---|---|---|
| | 9:00- | 9:15- | 9:30- | | Coinciding | Percentage of | Total Impact |
| | 9:15 | 9:30 | 9:45 | | Intervals | Usage | Score |
| “A” | 55% | 65% | 10% | “A” | 3 | 103 | 43.3 |
| “B” | 5% | | | “B” | 1 | 5 | 5 |
| “C” | 10% | | 5% | “C” | 2 | 15 | 7.5 |
| “D” | | 20% | 75% | “D” | 2 | 95 | 47.5 |
| “E” | | 5% | | “E” | 1 | 5 | 5 |

The diagnostics provider 345 executing on the performance analytics system 305 may identify or select a subset of processes 350. The subset of processes 350 identified by the diagnostics provider 345 may correspond to or may be correlated with those that are likely to contribute the most to the unsatisfactory user experience, and thus may be further investigated. The selection of the subset of processes 350 may be based on a total number of processes 350 across the identified time intervals 420 and a combination of the impact scores 420 across the processes 350. The subset of processes 350 may number a set proportion of the total number of processes 350 that in aggregate contribute to a set percentage of the combination (e.g., sum, weighted sum, or average) of the impact scores 420. In some embodiments, the set proportion and the set percentage may be fixed by the administrator of the performance analytics system 305. In some embodiments, the set proportion for the total number of processes 350 and the set percentage for the impact scores 420 may be dynamically determined by the diagnostics provider 345 based on measures corresponding to unsatisfactory user experience. In some embodiments, the diagnostics provider 345 may identify subsets of processes 350 for correspond usage metric types, such as by processor usage, memory consumption, or disk consumption, among others.

In some embodiments, the diagnostics provider 345 may select the set number of processes 350 with the highest percentages of usage that contribute to the set percentage of the combination of the impact scores 420. For instance, across the time intervals 410, the diagnostics provider 345 may identify the top n processes 350 that number 20% of the total number of processes 350 and that in aggregate contribute to 80% of the sum of impact scores 420. In some embodiments, the diagnostics provider 345 may rank the processes 350 based on the impact scores 420. The ranking may be by highest impact scores 420 for which the combination of the impact scores 420 at least is greater than the set percentage (e.g., 80% of the sum of the impact scores 420). Based on the ranking, the diagnostics provider 345 may select the subset of processes 350 for investigation.

In some embodiments, when the subset of processes 350 contribute to more than set percentage of the impact scores 420, the diagnostics provider 345 may exclude at least one of the process 350. The excluded process 350 may correspond to the one resulting to exceeding the set percentage. For example, the remainder of the identified processes 350 may in aggregate contribute to 75% of the total level of resource consumption 415, and the last process 350 may contribute to 10% of the total level of resource consumption 415. In this example, the diagnostics provider 345 may exclude the process 350 contributing the 10%. In some embodiments, the diagnostics provider 345 may include all the processes 350 contributing to more than the set percentage of the combination of the impact scores 420.

Upon selection, the diagnostic provider 345 may send, convey, or provide the subset of processes 350 for presentation or display on the interface 355. The diagnostics provider 345 may generate the interface 355 to include various information regarding the identified subset of processes 350. In some embodiments, the interface 355 may be provided to the administrator device 310 to present the selected subset of processes 350 along with various associated information. The interface 355 may be rendered as part of an application executing on the administrator device 310. The application may control various aspects of the machines 315, including establishment of user sessions, permitting access to process 350, and usage of resources by the processes 350 on the respective machines 315. The presentation of the processes 350 on the interface 355 may permit a system administrator to further investigate the selected processes 350. The presentation of the processes 350 may also allow the system administrator to take actions on the identified processes 350 to address the unsatisfactory user experience detected at the machine 315.

In providing, the diagnostics provider 345 may present the selection of the processes 350 ranked by the impact scores 420. The diagnostics provider 345 may also provide various information about the selected processes 350 for display via the interface 355. For example, the information may include the impact scores 420, the time intervals 410, the user identifier, the process identifier for each process 350, and the process name for each process 350, among others for presentation on the interface 355. In some embodiments, the information provided by the diagnostics provider 345 may be classified or categorized by the usage metric type. For instance, the interface 355 may present the impact scores 420 and the time intervals 420, as well as the identified processes 350 by CPU usage and memory consumption.

In some embodiments, the diagnostics provider 345 may present or provide for display a ranked order for the processes 350 on the interface 355. The ranked order may be based on the number of times that each process 350 is identified as having the percentage of the usage of the resource by the process 350 above the threshold across the time intervals 410. The ranked order may be based on the total impact score 420 for the identified processes 350. In some embodiments, the diagnostics provider 345 may present or provide for display a timeline view for the interface 355. The timeline view may be for at least one of the identified processes 350 to show usage of the resource by the process 350 at each time interval 410.

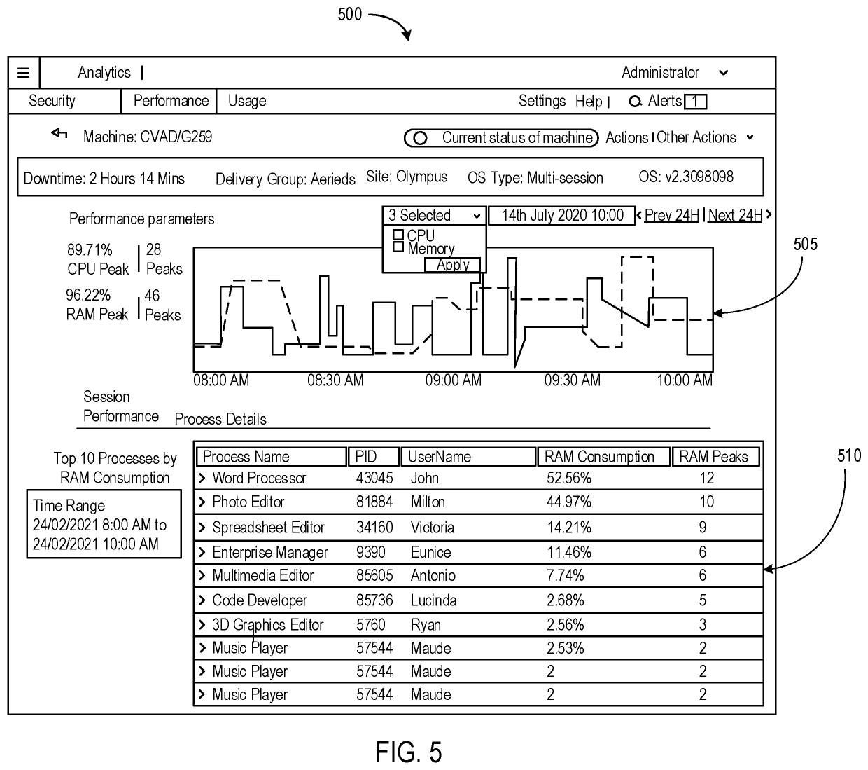

Referring to FIG. 5, among others, depicted is a screenshot of a graphical user interface 500 of an analytics platform presenting session-related performance parameters over time intervals. The graphical user interface 500 depicted may correspond to an example of the interface 355 generated by the diagnostics provider 345 as described above, and may be presented on the administrator device 310. As illustrated, the graphical user interface 500 may include a timeline view 505 and a list of processes 510, among other elements. The timeline view 505 may present the CPU usage (e.g., solid line) and the memory usage (e.g., dotted line) in terms of percentage across a timeline from 8:00 am to 10:00 am by various processes 350 on a given machine 315. The list of processes 510 may include a number of processes 350 (e.g., the top 10) identified as coinciding with the peaks in memory consumption at the machine 315. The list off processes 510 may include the process name, process identifier (“PID”), the user identifier (“UserName”), the memory consumption percentage (“RAM Consumption”), and the number of peaks in memory consumption (“RAM peaks”). The timeline view 505 and the list of processes 510 may permit the administrator to see an overall view of the consumption of computing resources by various processes 350 across multiple time intervals 410 and by different users.

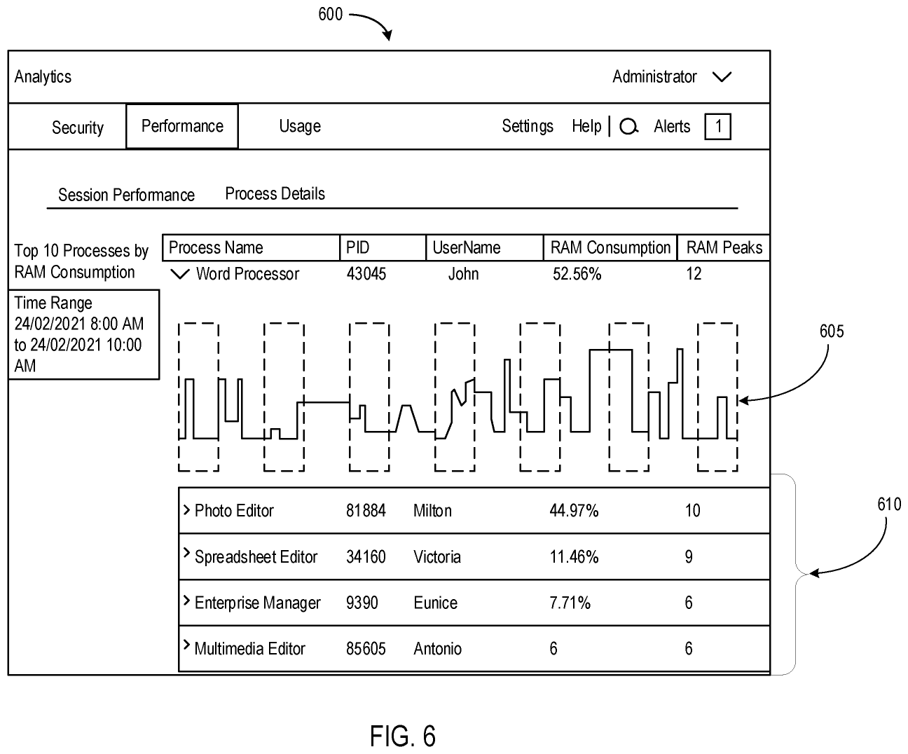

Referring to FIG. 6, among others, depicted is a screenshot of a graphical user interface600 of an analytics platform presenting session-related performance parameters over time intervals for a particular user. The graphical user interface 600 depicted may correspond to an example of the interface 355 generated by the diagnostics provider 345 as described above, and may be presented on the administrator device 310. As illustrated, the graphical user interface 600 may include a timeline view 605 and a list of processes 610, among others. The timeline view 605 may present a memory consumption across time intervals 410 in terms of percentage by one of the processes 350 (e.g., “Word Processor”) running on the machine 315. The timeline view 605 may allow the administrator to further investigate the consumption of memory resources by the selected process 350. The list of process 610 may include a number of processes 350 (e.g., the top 10) identified as coinciding with the peaks in memory consumption at the machine 315. The list off processes 510 may include the process name, process identifier (“PID”), the user identifier (“UserName”), the memory consumption percentage (“RAM Consumption”), and the number of peaks in memory consumption (“RAM peaks”) for the remaining processes 350 on the machine 315.

In addition, the diagnostics provider 345 may send, transmit, or provide an instruction to perform at least one action on one or more of the identified processes 350. The actions may include displaying a prompt notifying the user of the machine 315 regarding the process 350, terminating the process 350 on the machine 315, suspending the process 350 on the machine 315, or restrict computing resources from provision to the process 350, among others. The diagnostics provider 345 may select one or more actions to apply to each identified process 350 based on the impact score 420 for the process 350. For instance, when the impact score 420 for a process 350 is relatively higher, the action selected by the diagnostic provider 345 may be to terminate the process 350. Conversely, when the impact score 420 for a process 350 is relatively lower, the action may be to display a prompt warning the user about the process 350. In some embodiments, the diagnostics provider 345 may provide the action for display to the administrator via the interface 355. For example, the diagnostics provider 345 may provide the actions to the administrator as an recommendation to take on the identified processes 350. In some embodiments, the diagnostics provider 345 may send the instruction to the machine 315. Upon receipt the machine 315 may carry out the action specified by the instruction without any input from the administrator via the interface 355.

In this manner, the performance analytics system 305 may provide the interface 355 with various views showing processes that potentially contribute the degradation in machine performance and by extension issues with user experience. The interface 355 may allow the administrator to easily investigate the cause of the poor user experience at the machine 315, and quickly take actions to mitigate the contributory factors on the machine 315 running on the session, without having to manually investigate and deduce the factors. The performance analytics system 305 may thus improve the overall performance of the machine 315 and thereby increase the quality of human computer interactions (HCI) between the users and the processes 350 thereon.

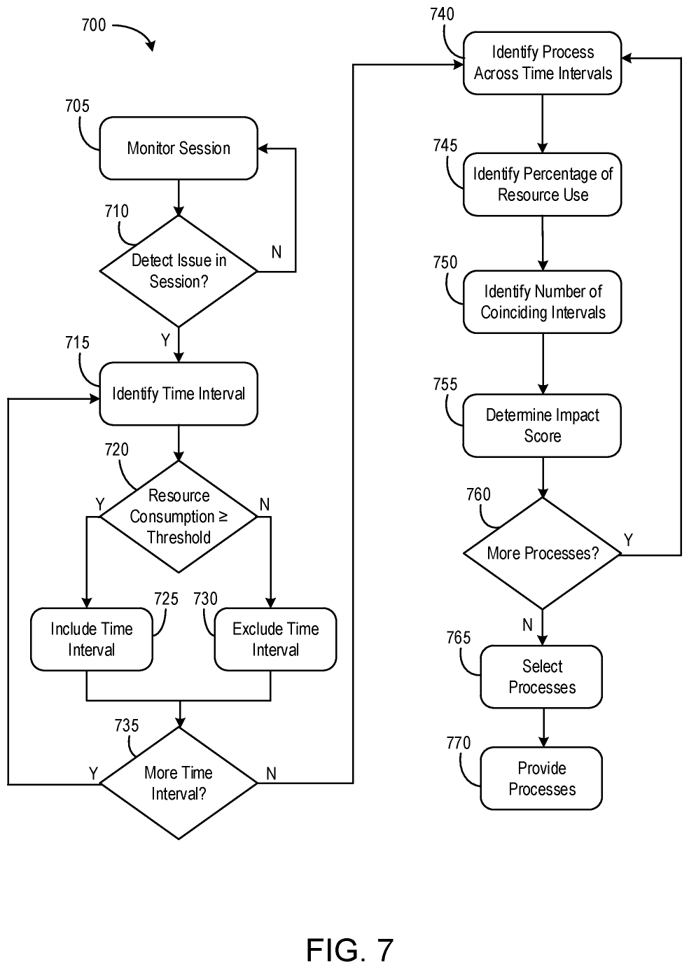

Referring now to FIG. 7, depicted is a flow diagram of a method 700 of detecting processes causing degradation of machine performance using heuristics. The operations and functionalities of the method 700 may be performed by the components described in FIGS. 1A-3, such as the performance analytics system 305 detailed above. In brief overview, a computing system may monitor a session (705). The computing system may detect an issue in the session (710). If an issue is detected, the computing system may identify a time interval (715). The computing system may determine whether a resource consumption is greater than or equal to a threshold (720). When the resource consumption is greater than or equal to the threshold, the computing system may include the time interval (725). Otherwise, when the resource consumption is less than the threshold, the computing system may exclude the time interval (730). The computing system may determine whether there are more time intervals (735). If there are no further time intervals, the computing system may identify a process across the time intervals (740). The computing system may identify a percentage of resource use (745). The computing system may identify a number of coinciding time intervals (750). The computing system may determine an impact score (755). The computing system may determine whether there are more processes (760). If there are no more processes, the computing system may select processes (765). The computing system may provide processes (770).

In further detail, a computing system (e.g., the performance analytics system 305) may monitor a session on a machine (e.g., the machine 315) (705). The session may correspond to or refer to a period of activity between one or more users and the machine to access and use various processes (e.g., the processes 350) on the machine. In monitoring, the computing system may measure for user experience related metrics, such as a response time, a number of reconnection attempts, an error rate, and a processing system among others. The computing system may detect an issue in the session (710). The computing system may determine a user experience score based on the related metrics. Upon determination, the computing system may compare the user experience score with a threshold. When the user experience score satisfies (e.g., is greater than or equal to) the threshold, the computing system may determine no issues with the session and repeat the functionality of (705). Otherwise, when the user experience score does not satisfy (e.g., is less than) the threshold, the computing system may detect an issue with the session.

If an issue is detected, the computing system may identify a time interval (e.g., the time interval 410) (715). The computing system may identify the time interval from a time period spanning the session on the machine. The time interval may correspond to a subset of the time period of the session. The computing system may identify or determine a level of resource consumption (e.g., the level of resource consumption 415) used by the processes in the identified time interval. The resource consumption may measure the amount of processor, memory, or disk space is consumed by the machine during the time interval. The computing system may determine whether the resource consumption is greater than or equal to a threshold (720). The computing system may compare the resource consumption determined for the time interval with the threshold. When the resource consumption is greater than or equal to the threshold, the computing system may include the time interval for additional analysis (725). Otherwise, when the resource consumption is less than the threshold, the computing system may exclude the time interval from the additional analysis (730). The computing system may determine whether there are more time intervals (735). If there are any more time intervals from the session, the computing system may repeat the functionalities from (715).

If there are no further time intervals, the computing system may identify a process across the time intervals (740). The process may be executing on the machine during one or more of the included time intervals. The computing system may identify a percentage of resource use consumed by the process across the time intervals (745). The percentage of resource usage may correspond to an amount of resources by the individual process relative to the total level of resource consumption at each time interval. The computing system may calculate the sum of the percentages of resource use across the time intervals. The computing system may identify a number of coinciding time intervals (750). The computing system may identify the number of times the identified process appears across the time intervals. The computing system may determine an impact score (e.g., the impact score 420) (755). The impact score may be determined as a function of the percentage of resource use across the time intervals and the number of coinciding time intervals. The computing system may determine whether there are more processes (760). If there are more processes to be analyzed, the computing system may repeat the functionality of (740).

If there are no more processes, the computing system may select processes based on impact scores (765). The computing system may identify the processes that constitute a set percentage of the total number of processes identified across the time intervals and that contribute to a set proportion of the total sum of the impact scores. The computing system may provide processes (770). Upon selection of the processes, the computing system may provide the selection via an interface (e.g., the interface 355) for display to an administrator. The interface may include a timeline view of the resource consumption across the time interval in aggregate or for each of the processes. The interface may also include a list of processes showing the selected processes and the percentage of resource use and other associated information. In addition, the computing system may provide actions to take on the identified processes. The actions may be selected based on the impact scores of the processes.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method, comprising:
identifying, by a device, a plurality of time intervals having a use of a resource on a machine above a threshold;
identifying, by the device, a percentage of the use of the resource by each of a plurality processes on the machine using the resource during each time interval of the plurality of time intervals;
determining, by the device, a score for each process of the plurality processes based at least on a function of the percentage of the use of the resource over one or more of the plurality of time intervals in which each process used the resource; and
providing, by the device for display, a selection of one or more processes from the plurality of processes ranked by the score.

2. The method of claim 1, further comprising selecting, by the device, the one or more of processes from the plurality of processes ranked by highest score and for which a sum of the scores at least meets a second threshold.

3. The method of claim 1, further comprising identifying, by the device, for each of the plurality of processes, an identifier of a user using the process.

4. The method of claim 3, further comprising providing, by the device display, the score and the identifier of the user for each of the plurality of processes.

5. The method of claim 1, further comprising identifying, by the device, a number of times each of the plurality of processes across the plurality of time intervals identified as having the use of the resource on the machine above the threshold.

6. The method of claim 5, further comprising providing, by the device for display, a ranked order of the number of times that each of the plurality of processes is identified as having the use of the resource on the machine above the threshold across the plurality of time intervals.

7. The method of claim 1, further comprising providing, by the device for display, a timeline view for a process of the one or more processes to show usage of the resource by the process at each of the plurality of time intervals.

8. The method of claim 1, wherein identifying the plurality of time intervals further comprises identifying, responsive to detecting a degradation of a session, the plurality of time intervals from the session.

9. The method of claim 1, wherein identifying the percentage of the use of the resource further comprises identifying the percentage of the use of the resources by each of the plurality processes on the machine above a second threshold.

10. The method of claim 1, further comprising providing, by the device, an instruction to perform an action to at least one of the one or more processes based at least on the score for each of the one or more processes.

11. A system, comprising:
one or more processors coupled with memory, configured to:
identify a plurality of time intervals having a use of a resource on a machine above a threshold;
identify a percentage of the use of the resource by each of a plurality processes on the machine using the resource during each time interval of the plurality of time intervals;
determine a score for each process of the plurality processes based at least on a function of the percentage of the use of the resource over one or more of the plurality of time intervals in which each process used the resource; and
provide, for display, a selection of one or more processes from the plurality of processes ranked by the score.

12. The system of claim 11, wherein the one or more processors are further configured to select the one or more of processes from the plurality of processes ranked by highest score and for which a sum of the scores at least meets a second threshold.

13. The system of claim 11, wherein the one or more processors are further configured to identify a number of times each of the plurality of processes across the plurality of time intervals identified as having the use of the resource on the machine above the threshold.

14. The system of claim 13, wherein the one or more processors are further configured to provide, for display, a ranked order of the number of times that each of the plurality of processes is identified as having the use of the resource on the machine above the threshold across the plurality of time intervals.

15. The system of claim 11, wherein the one or more processors are further configured to provide a timeline view for a process of the one or more processes to show usage of the resource by the process at each of the plurality of time intervals.

16. The system of claim 11, wherein the one or more processors are further configured to identify, responsive to detecting a degradation of a session, the plurality of time intervals from the session.

17. The system of claim 11, wherein the one or more processors are further configured to identify the percentage of the use of the resources by each of the plurality processes on the machine above a second threshold.

18. A non-transitory computer-readable medium storing program instructions to cause one or more processors to:
identify a plurality of time intervals having a use of a resource on a machine above a threshold;
identify a percentage of the use of the resource by each of a plurality processes on the machine using the resource during each time interval of the plurality of time intervals;
determine a score for each process of the plurality processes based at least on a function of the percentage of the use of the resource over one or more of the plurality of time intervals in which each process used the resource; and
provide, for display, a selection of one or more processes from the plurality of processes ranked by the score.

19. The non-transitory computer-readable medium of claim 18, wherein the program instructions cause the one or more processors to select the one or more of processes from the plurality of processes ranked by highest score and for which a sum of the scores at least meets a second threshold.

20. The non-transitory computer-readable medium of claim 18, wherein the program instructions cause the one or more processors to identify a number of times each of the plurality of processes across the plurality of time intervals identified as having the user of the resource on the machine above the threshold.
